(19) United States
(12) Patent Application Publication
(10) Pub. No.: US 2004/0111318 A1
(43) Pub. Date: Jun. 10, 2004

(54) Marketing scheme

(75) Inventor: Karin Hayhow, Edinburgh (GB)

Correspondence Address: DRINKER BIDDLE & REATH, ONE LOGAN SQUARE, 18TH AND CHERRY STREETS, PHILADELPHIA, PA, 19103-6996, US

(73) Assignee: Winningnote Limited, Edinburgh (GB)

(21) Appl. No.: 10/650,318

(22) Filed: Aug. 28, 2003

(30) Foreign Application Priority Data
Aug. 30, 2002 (GB) 0220163.0

(51) Int. Cl. G06F 17/60

(52) U.S. Cl. 705/14

(57) ABSTRACT

A method of operating a marketing scheme including registering a first party with the scheme operator, and issuing a respondable transmissible element to the first party for onward transmission to a plurality of receiving parties. The method of onward transmission is direct transmission by said first party, or indirect transmission by a receiving party who has received the transmissible element from one of said first and receiving parties. The method further includes receiving a response to a transmissible element from a second party which is one of said plurality of receiving parties, comparing the accumulated total of responses received from said plurality of receiving parties with a target total, and delivering a first prize to the second party if the accumulated total of received responses equals the target.

### FIELD OF THE INVENTION

This invention relates to a marketing scheme and in particular to a marketing scheme implemented on the Internet. The term marketing is used throughout this specification to refer to marketing or promotional advertising.

### BACKGROUND OF THE INVENTION

With the growth in Internet advertising, users are being increasingly bombarded with advertisements and are consequently becoming less receptive thereto. Similarly, given the wealth of sites available on the Internet, advertisers are finding it increasingly difficult to attract and retain a user's attention in an advertisement or brand-owner's web-site as the user can quickly move onto other sites.

Personal recommendation or word of mouth advertising has traditionally been recognised as a very powerful form of advertising and is based on the premise that a customer who has been satisfied with a product or service will recommend it to their friends and family and will thereby become an advocate for the product or service provider.

Word of mouth advertising has a parallel in the Internet known as viral marketing. Viral marketing is an advertising strategy that is used to encourage individuals to voluntarily pass on a marketing message to others. Since a recipient of any such marketing message will recognise it as emanating from a known friend or family member, the recipient is likely to be more receptive to the message than if it had been sent from an unknown source. Furthermore, since each recipient of the message can pass it on to a number of other persons, there is a potential for an exponential growth in the message's exposure.

A number of viral marketing strategies are employed on the Internet to convey sales messages or build up brands and characteristically provide different incentives (e.g. free web-space, free software etc.) to users to pass on marketing messages. However, such systems do not provide an incentive for a recipient to read and forward the message and rely on the fact that the message emanates from a known source to attract the attention of the recipient.

### OBJECT OF THE INVENTION

It is an object of the invention to overcome the problems in the prior art.

### SUMMARY OF THE INVENTION

According to the invention there is provided a method of operating a marketing scheme comprising the steps of:

(a) registering a first party with the scheme operator;

(b) issuing a respondable transmissible element to the first party for onward transmission to a plurality of receiving parties, the method of onward transmission being selected from the group comprising of direct transmission by said first party and indirect transmission by a receiving party who has received the transmissible element from one of said first and receiving parties;

(c) receiving a response to a transmissible element from a second party which is one of said plurality of receiving parties;

(d) comparing the accumulated total of responses received from said plurality of receiving parties with a target total; and

(e) delivering a first prize to the second party if the accumulated total of received responses equals the target.

Preferably, a second prize is also delivered to a third party from whom the second party received the transmissible element.

Preferably, the second party is offered a transmissible element if the accumulated total of received responses is less than the target.

Desirably, a fourth party is registered with the scheme operator prior to the commencement of the marketing scheme.

Preferably, the target is determined by the fourth party who also donates at least one prize. The target is established in accordance with the value and number of the first and second prizes.

Preferably, the transmissible element is selected from the group comprising HTML and textual messages and may be customised in accordance with the requirements of the fourth party. The transmissible element further comprises instructions on how it should be used to win a prize. The transmissible element further comprises a responding means chosen from the group comprising of a hyperlink and an email address to a recording centre.

Optionally, prior to registration the first party is shown the prizes donated by the at least one fourth party. The first party is permitted to select a prize and is permitted to register to acquire the transmissible element.

Preferably, the registration form is customised to meet the requirements of the fourth party and must be completed by the first party before issue of the transmissible element. The information provided by the first party may be validated before a transmissible element may be sent to the first user.

Optionally, the transmissible element is sent to the first party in an email further including instructions on how it should be transmitted to further parties. To win the prize the first party must transmit the transmissible element to a receiving party.

Optionally, on receipt of the transmissible element, the receiving party is advised of their chance to win the prize and may be invited to respond to the transmissible element. On responding to the transmissible element, the receiving party and the first party become the second party and the third party respectively to the subsequent proceedings.

Optionally, if the second party does not win the prize, the second party is required to provide information in accordance with the requirements of the fourth party in order to obtain a transmissible element. On receipt of the transmissible element, the second party is advised on how to transmit the transmissible element to other parties.

Preferably, the second party must transmit the transmissible element to a receiving party in order to win the prize. If the receiving party responds to the transmissible element, the second party and the receiving party become the third party and the second party respectively to the subsequent proceedings.

Preferably, if the accumulated number of received responses matches the target, the second party is requested to transmit information to a recording centre and to provide a copy of the transmissible element thereto to enable the recording centre to verify that the second party's email address is not identical to that of the third party.

Preferably, once the prize is won, registrants for the prize are informed of the fact, with a request that no further transmissions are made in respect of the prize and no further registrations therefor are accepted.

Optionally, the registration by the first party is added to the accumulated total of received responses. In the event that a first prize is delivered to the first party without the delivery of a second prize to the second party, the at least one remaining prize is used in a periodic random draw amongst all the registered parties.

Further optionally, in addition to sending the transmissible elements to individual parties based on specific requests therefor, transmissible elements are sent out to groups of parties without prior request therefor.

According to a second aspect of the invention there is provided a system for implementing a marketing scheme comprising of a scheme database containing details of available marketing schemes and the operators of said marketing schemes; a prize offer database containing details of prizes made available by the marketing scheme operators; an advertisement database containing advertisements; and a response database containing details of respondents to the marketing scheme, wherein these databases are accessible by a user software module and a logic software module so that the prizes in the prize offer database are displayed by the user software module, details of registrants for the marketing scheme acquired by the user software module are stored in the response database and a generation of transmissible elements comprising of advertisements from the advertisement database, a transmission of appropriate transmissible elements to persons whose details are stored in the response database, a storage of responses to the transmissible elements in the response database and a decision process for prize grant are collectively controlled by the logic software unit.

Preferably, the system for implementing the marketing scheme further comprises an administration module and an advertiser administration module. The administration module enables suitably empowered parties an ability to add marketing scheme operators, campaign details and their marketing schemes to the scheme database and to generate reports of marketing scheme statistics. The advertiser administration module enables suitably empowered marketing scheme operators to generate their own reports of statistics relating to their own marketing schemes and further add information relating to their marketing schemes to the scheme database.

### BRIEF DESCRIPTION OF THE DRAWINGS

An embodiment of the invention will now be described by way of example only with reference to the accompanying drawings in which:

FIG. 1 is a flow chart of the processes occurring in the marketing scheme in accordance with the invention;

FIG. 2 is a screen shot of an email with a note from the scheme operators attached to its end, which contains example offer content for a transmissible element;

FIG. 3 is a schematic representation of the relationships between the marketing scheme web-site and participants in the marketing scheme for a simple example scenario;

FIG. 4 is a block diagram showing the relationships between the databases and software modules which comprise the system architecture;

FIG. 5 is a block diagram showing the software components of the user's module of the system software; and

FIG. 6 is a block diagram showing the hierarchical relationship between the software components of the administration module of the system software.

### DESCRIPTION OF THE INVENTION

Referring to the accompanying figures this description will start with a discussion of the processes occurring in the software and will end with a description of the system architecture.

Process Description

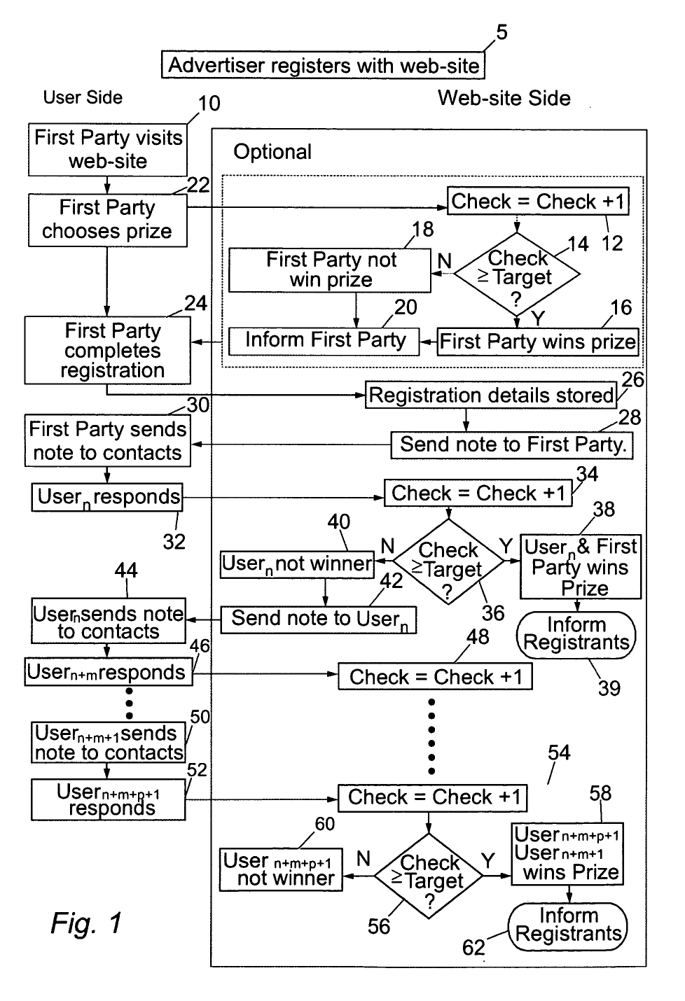

Referring to FIG. 1, in a first stage 5 of the marketing scheme a fourth party who will henceforth be referred to as an advertiser (but could equally be a brand-owner or a promoter) who wishes to participate in the marketing scheme registers with the web-site and offers the scheme operators two or more prizes to be used in the advertiser's advertisement campaign. The advertiser also agrees with the scheme operator on a target number of responses for the advertisement campaign. The target number of responses may or may not be set with reference to the recommended retail price of the prizes.

The advertiser designs their advertisement message which is incorporated by the scheme operators into a transmissible element which will henceforth be known as a note. The note may be further branded with the advertiser's logo and provided with a hyperlink to the advertiser's home-page.

A first party learns of the web-site and visits the web-site 10. The first party browses the available prizes and chooses the prize(s) he wants to win 22. By clicking on an appropriate hyperlink (e.g. http://www.website/ADVERTISER/prizeoffer_template) the first party is directed to offer detail and a registration form which must be completed to obtain a note from the scheme operators.

The amount and type of information demanded from the first party is customisable to meet the advertiser's needs by requiring that particular fields in the registration form must be filled before the registration will be accepted and making the filling of the other fields in the registration form optional. At a minimum, the first party will be required to provide their name and email address before a note will be issued.

On receiving the first party's details the scheme operators will validate the details. If the details provided by the first party do not satisfy the advertiser's requirements, the first party will be informed of the fact by the web-site and will be prompted to enter the details again until the provided details do satisfy the advertiser's requirements on the registration form. Once the provided details satisfy the advertiser's requirements, the details will be stored 26 and the web-site will issue the corresponding transmissible element (henceforth known as a note) to the first party 28 as part of the message body of an email. The note will be written by default in HTML, however, a text version of the note can be read by email programmes which do not support HTML.

The note will contain personalised information in the form of the email address of the first party and will be provided with an explanation of how to insert the note into an email (e.g. by cutting and pasting the note onto new emails, forwarding the issuer's mail, or saving the note and either using it as a signature, or sending it as an attachment on new emails).

The first party will insert the notes into their own emails using one of the above methods and will send the notes to as many contacts as he/she wishes 30. To simplify the following description, a receiving party henceforth known as a recipient, of a note who did not acquire it from the web-site, will be described as a Userₓ wherein x varies according to the context in which the user acquired the note. Thus, if an first party sends the note to n persons, those persons will be described as User₁ to Userₙ.

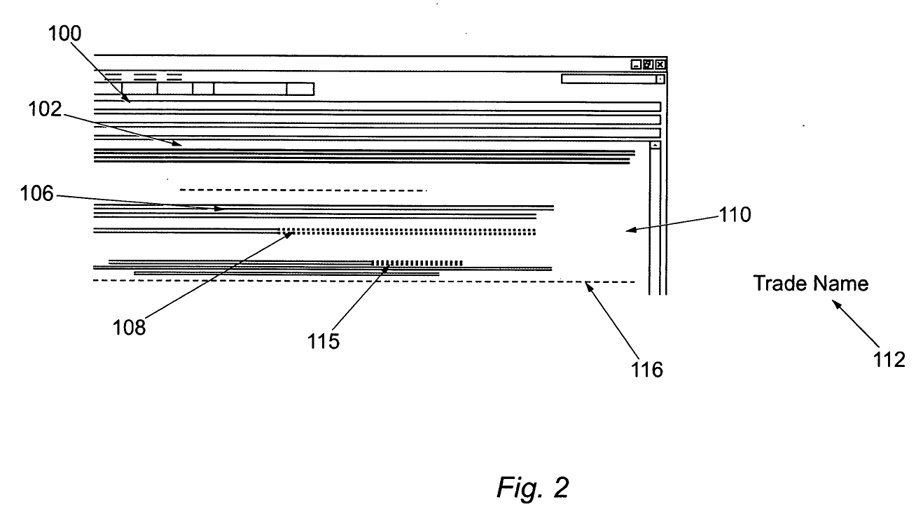

An example of an email containing a note is shown in FIG. 2. The email comprises the normal recipient's email address 100 and the textual description of the purpose of the email (i.e. content of email from sender to recipient) 102. The note 104 appears at the bottom of the email and comprises a description of the prize chosen by the first party 106 and instructions on how to respond to win the prize 108 by hyperlink or email. The note 104 further comprises the optional inclusion of an advertiser's message 110 which may include the advertiser's brand 112 and a hyperlink to the advertiser's home-page. The note 104 may further include information on the target number of responses for the prize, details of the terms and conditions 115 of the prize offer and the target number of responses for the prize offer 116. The note is terminated with a hyperlink to the marketing scheme web-site 117, a prompt to visit the site to see other prizes and an email contact address, 118. The content is editable for customisation to meet the advertiser's needs.

Returning to FIG. 1, for a recipient to learn whether or not they have won the prize described in the note, they must respond 32 to the note. The response may take the form of an email to the operator using an email address (e.g. havewewon.ADVERTISER@website.com)or hyperlink thereto, cited in the instructions 108 in FIG. 2 in the received note. The response may also take the form of an on-line visit to the marketing-scheme web-site (e.g. http://www.website.com/ADVERTISER/klick_check) through a hyperlink included in the instructions 108 in FIG. 2 in the received note.

If responding to the note using the hyperlink included in the note, the user (e.g. Userₙ) must enter their name and email address. The email address of the sender of their note is automatically generated. If responding to the note by email the user (e.g. Userₙ) need only send a blank email to the email address provided in the note.

Each time a response to a note is received, a record is made thereof. To simplify the following description, the number of recorded responses will be referred to henceforth as checks. On receipt of a response to a note, the checks acquired for the corresponding advertising campaign is incremented 34. The resulting checks are then compared with the target number of responses established by the advertiser for the advertising campaign 36. Once the checks reaches the target number of responses for the advertising campaign, prize delivery is triggered 38.

If on receipt of a response to a note, the resulting incremented checks equals the target number of responses for the prize offer, then both the sender of the response (henceforth known as a second party to the proceedings) and a third party who sent him the note will win a prize 3 8. For example, in the case of a note sent to Userₙ by the first party, both the first party and Userₙ will win the prize. In the above case the Userₙ is a second party to the proceedings and the first party (who received the note originally from the web-site operators) is a third party to the proceedings. However, as will be seen later a note can be sent to a recipient by persons other than the first party or the web-site operators. Consequently, the third party to the above proceedings might be the first party or some other person depending on the circumstances in which the note was transmitted to the second party.

Regardless of the identity of the second and third parties to the above proceedings, if the number of received responses to a note equals the target number of responses for the prize offer a congratulatory message will be sent to the second party, which will tell the second party of his success. The second party may be requested to forward their note to winnercheck@website.com so that the scheme operators may inform both winners (i.e. the second and the third parties) of their success. The winning parties will be required to sign a declaration that they have complied with the terms and conditions imposed by the advertisers and scheme operators.

An inspection of the note in question represents one potential way in which the identities of the second and third parties may be verified to ensure that the identities of the parties in question are not identical. The identities of the second and third parties might be identical if a person attempted to cheat the marketing scheme by maintaining multiple email addresses, passing a note between the addresses and responding to the note from each address until the target number of responses had been reached. The note is further examined by checking that the email address of the third party is registered on the web-site, to ensure that the third party is an authorised sender of a note. Further investigations of the identities of the second and third parties may be performed based on the ownership of the email address of the parties in question and their home addresses.

The competition is closed on reaching the target number of responses and all the registrants for the prize offer are sent an email informing them that the prize has been won and that the offer has been closed as a result 39 and instructing them to stop transmission of the note. If any responses are received in respect of a prize offer after its closure, the senders of the responses in question are transmitted an automatic reply informing the senders that the prize has been won and the prize offer has been closed.

If on receipt of a response to a note, the target number of responses to the advertising campaign has not been met, a consolation message will be issued to the respondent 40, informing the respondent that they have been unsuccessful in their attempt to win the prize and offering the respondent the opportunity to include a note in their own emails and win the prize if the response of one of its recipients meets the target number for the advertising campaign.

Depending on the requirements of the advertiser and consent of the respondent, the respondent may be sent a note automatically with their consolation email 42, or alternatively, the user may be presented with a hyperlink to a registration form (e.g. www.website.com/ADVERTISER/prizeoffer) which the respondent will be required to complete before obtaining their note.

On receiving a response to a note, the respondent's email address may be excluded from any further attempts to win the corresponding prize by responding to a received note. Some advertisers may wish to offer a respondent more than one opportunity to win a prize, by responding to a received note, and consequently the respondent's email address will only be excluded from any further attempts to win a prize, by responding to a received note, if the number of responses already received from the email address exceeds a predefined threshold for the offer in question.

Having failed to win a prize by responding to a received note, a second party may register with the web-site to receive a note for transmission to their own contacts or may have requested automatic receipt of one of such notes from the web-site operators. On receipt of the note, the second party may send the note to his own contacts and thereby obtain another chance to win the prize if the recipient of the note responds to the note and the resulting incremented total of checks reaches the target number of responses for the prize offer (in this case the recipient of the note also wins the prize).

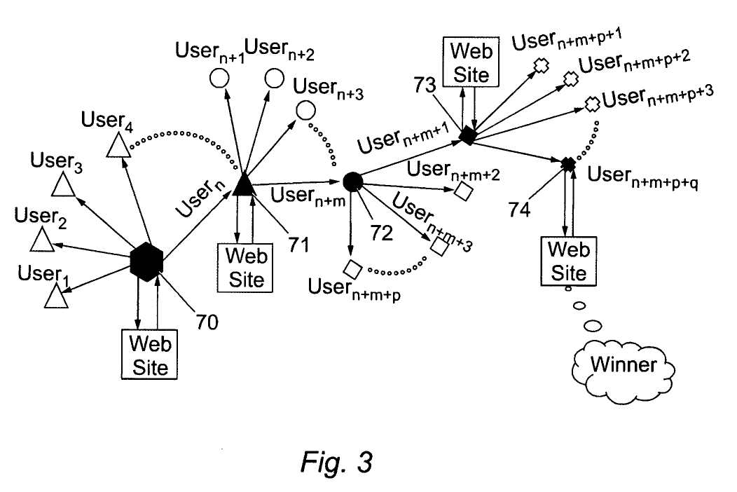

In a simple example, referring to FIGS. 1 and 3, if an first party 70 sends a note to n persons and one of those recipients (namely Userₙ 71) responds to the note but fails to win a prize and transmits the note to m persons, then n+m+1 persons have seen the advertisement (i.e. all the recipients of the note and the first party 70). If one of the m persons (namely Userₙ₊ₘ 72) responds to the note but fails to win the prize and sends the note to p persons then n+m+p+1 persons have seen the advertisement. If one of those p persons namely Userₙ₊ₘ₊₁ 73 responds to the note but fails to win the prize and sends the note to q persons then n+m+p+q+1 persons have seen the advertisement. If one of those q persons namely User_{n+m+p+q} 74 responds to the note and wins the prize then the User_{n+m+p+q} 74 and Userₙ₊ₘ₊₁ 73 will win a prize each.

Clearly, the results of the marketing scheme may become much more complex because there may be more than one first party of an offer and more than one of the n recipients may respond to the note (if all n recipients responded there would be n checks). If all n recipients were not to have won the prize and sent a note to m persons each who all responded to the note then nxm checks would be received. Similarly if none of the m recipients won a prize and each sent a note to p persons then nxmxp checks would be received.

The resulting effect of this process is a potentially exponential growth in the number of persons exposed to the brand owner's advertisement with the spontaneous generation of independent “chains” of emails containing notes. Regardless of the complexity of the results, the advertiser pays for the number of received responses to the issued notes for their advertising campaign.

In a further embodiment the act of registering with the web-site by the first party is itself counted as a check 12. Consequently, if enough checks have been acquired prior to the registration by an first party, the check resulting from the first party's registration could equal the target number of responses set by the advertiser and the first party could thus win the prize. In such a case, since the advertiser's note has not been sent by the first party to any person yet, there is no other person to whom a prize should be given by the scheme operators, thus at least one prize will remain, which will be used by the scheme operators in a draw amongst all those persons who have registered for that prize.

In a further embodiment, in addition to sending the notes to individuals based on specific requests therefor, the web-site may also send out notes in bulk emails to variably sized mailing lists (e.g. Friends_of Brand_Owner), that may be personalised by inserting the email address of each member of the mailing list into each note. In this case if each member of the mailing list includes the note in their own emails, the members of the mailing list each become a first party in the process.

System Architecture

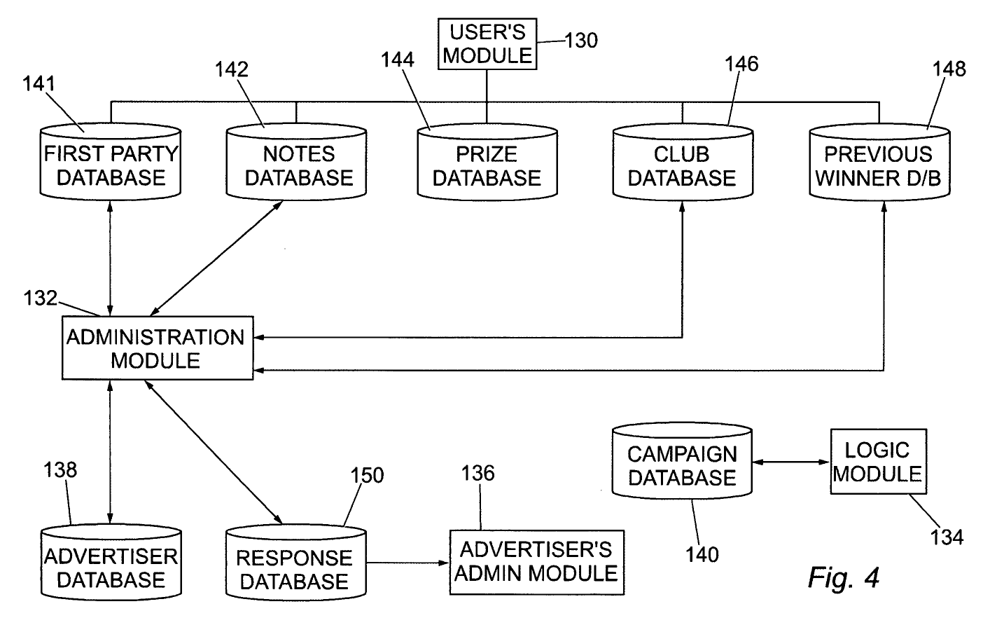

Referring to FIG. 4, the system can be divided into a user's module 130, an administration module 132, a logic module 134 and an advertiser's administration module 136. The modules in turn have access to an advertiser database 138, a campaign database 140, a first party (originator) database 141, a note database 142, a prize offer database 144, a web-site club membership database 146, a previous winners database 148 and note response database 150.

1. User's Module 130

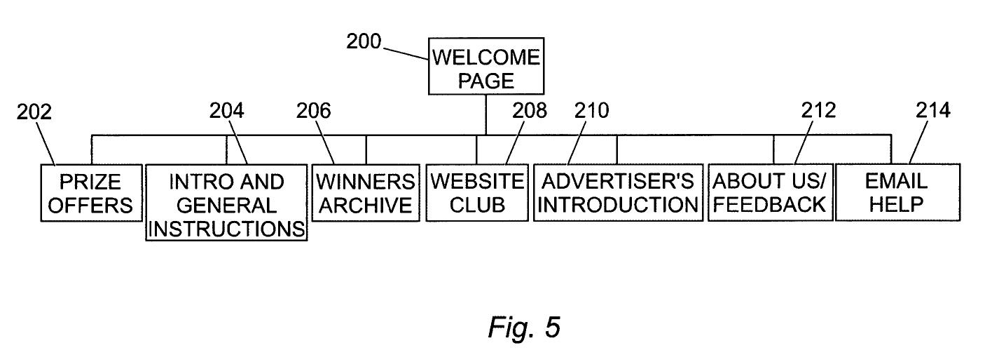

Referring to FIG. 5, the user's module 130 can be divided into the following sections (as illustrated in FIG. 5):

(i) Welcome Page 200

(ii) Prize-offers section 202

(iii) Introduction and general instructions section 204

(iv) Winners archive 206

(v) Web-site club 208

(vi) Potential advertisers introduction section 210

(vii) Explanation Section 212

(viii) Email Help Section 214

ii. Prizes Offers Section 202

The prize offers section (e.g. www.website.com/prizeoffers.html) comprises a page providing an explanation of the marketing scheme and links to a database containing details of the prize offers made by client advertisers. All of the currently active prize offers can be inspected online from a paginated list filled from the prize offer database 144. Each page will show a maximum of 5 to 10 prize offers.

Each displayed prize offer includes the brand name of the brand-owner in question and an image and description of the prize. Each prize offer further includes details of the date on which the prize was offered, the prize's value (e.g. recommended retail price), the broad category of goods into which the prize falls (e.g. cars, toys, household goods etc.), the area in which the prize can be delivered (if the prize is a product) or the location in which the prize can be provided (if the prize is a service). The prize offers can be sorted by date (the default), brand name, value, area and category, and displayed accordingly.

If a competition has recently been closed (because the associated prize has been won in the last thirty days), the corresponding prize offer is replaced with a standard message advising that the prize has been won.

A note can be requested from the note database 142 by registering with the first party database 141 from any of the currently active prize offers listed in the prize offers section through an appropriately branded landing page or registration form.

iii. Introduction and General Instructions Section 204

The introduction and general instructions section is-a static page (e.g. www.website.com/instructions.html) advising new users on how they can use a note to win a prize.

iv. Winners Archive 206

The winners archive section is a page (e.g. www.website.com/winners-archive.html) of news items providing details and stories of past winners dynamically generated from the previous winners database 148.

v. Web-site Club 208

In the web-site club section, users have the option of registering (through a profiling questionnaire which includes indication of interest by category) with the web-site mailing list. If the user chooses to join the mailing list their details will be stored in the web-site club membership database 146 and the user will be sent newsletters to keep them apprised of new offers.

vi. Potential Advertisers Introduction Section 210

The potential advertisers introduction section comprises a page (e.g. www.website.com\advertiser.html) explaining the marketing scheme and the benefits to potential advertisers of participating therein. The potential advertisers introduction section also includes an contact form email link (e.g. info@website.com) which the potential advertiser can use to request contact and further information from the scheme operators.

vii. Explanation Section 212

The explanation section comprises a static page (e.g. www.website.com/about_us.html) providing information to users and advertisers about the web-site, the marketing scheme and the people involved in its operation. This section also includes a feedback form (or a link thereto) to enable users to provide comments and ask to be contacted by the scheme operators in response thereto.

viii. Email Help Section 214

The Email help section is a static page with information on how to use the note in different types of Email format.

2. Administration Module 132

In the administration module 132 (e.g. www.website.com/admin) the scheme operators have access to a password protected suite of administration tools.

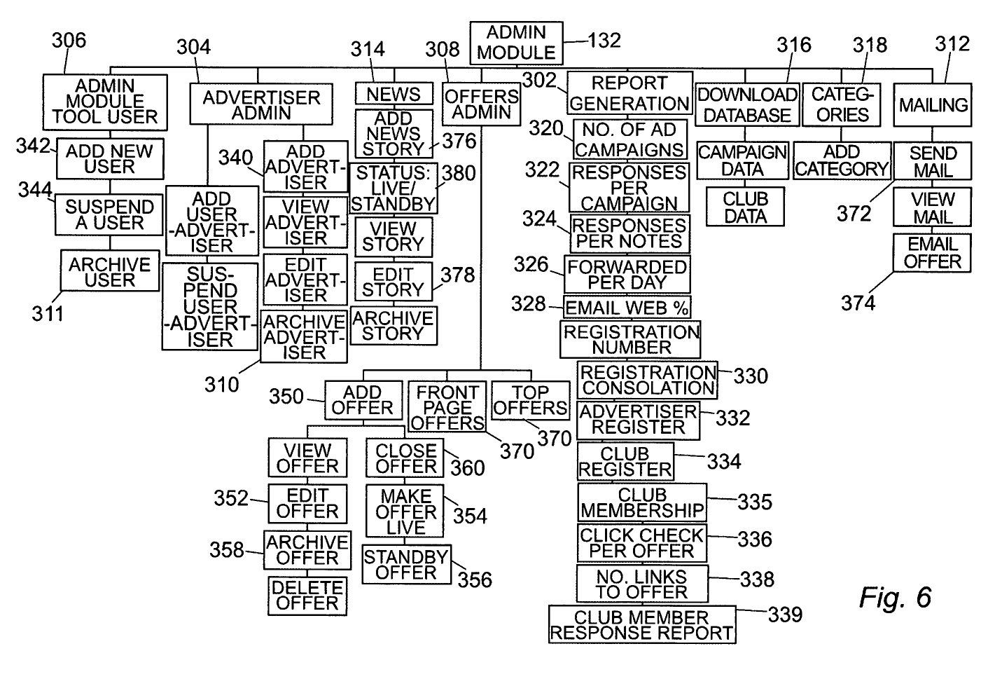

The administration tools (as shown in FIG. 6) provided in the administration module include:

(i) Report generation tool 302

(ii) Advertiser administration tool 304

(iii) Administration module user tool 306

(iv) Offers administration 308

(v) Mailing tool 312

(vi) Create/edit news stories tool 314

(vii) Download database tool 316

(viii) Categories tool 318

Administration module users can have different levels of access to administration tools. A super administration module user has access to all of the administration tools, whereas other administration module users are not permitted access to the archive advertiser, archive administration module user, send mail, create/edit news stories and download database tools.

i. Report Generation Tool 302

Reports can be generated from the following data;

(a) Number of advertising campaigns 320

More detailed information on the number of advertising campaigns operated by the web-site can be provided by enumerating the campaigns according to their status (namely standby, live and closed).

(b) The number of note responses recorded each day for each campaign 322.

(c) The number of responses recorded for each note issued (only applicable to web-based responses) 324.

(d) The number of forward transmissions recorded per 24 hours 326.

(e) The percentage of recorded note responses which were received from emails compared with the percentage received through the web-site hyperlink 328.

(f) The number of prize-offer (first party) registrations

(g) The number of registrations made after receipt of consolation messages and total number of consolation messages issued 330.

(h) The number of opt-ins to advertiser's email list or registration daily 332.

(i) The number of opt-in registrations to the web-site club and to the advertiser list daily from registrations 334.

(j) The number who join the club on the web-site 335.

(k) The number of clicks on each prize offer from the list on the prize offer page 336.

(l) The daily number of links from website.com onto a prize offer maintained by the web-site as a fraction of the number of links to the prize offer from an advertiser's own site 338.

(m) The number of web-based responses to each club member's notes for each campaign.

In order to generate these reports, the report generation tool accesses the note database 150, the prize-offer database 144, the advertiser database 138, the first party database 141, the response database 150 and the web-site club membership database 146.

ii. Advertiser Administration 304

(a) Using the add advertiser tool 340, an administration module user can add an advertiser to the list of client advertisers stored in the advertiser database 138. All the advertiser's details can be entered into the system by way of a form which must be completed by the advertiser or the scheme operator. In this manner, the form may also represent the Campaign Agreement Form. The details stored for each advertiser may be viewed.

(b) Using the archive advertiser tool a super administration user can archive an advertiser.

(c) Advertiser Access

The super administration user can add an advertiser user or suspend advertiser users. The advertiser user then gains access to password protected administration area with report tools.

iii. Administration Module User Tool 306

Using the administration module user tool, an administration module user can add a person to the list of authorised existing administration module users 342. Using the suspend 344 or archive 311 tools, the super administration user can suspend or archive other users.

iv. Offers Administration 308

(a) Add Offer 350

An administration module user can add, edit and delete details for an offer or advertising campaign operated for a client advertiser to the list of offers stored in the campaign database 140.

Notes are designated in the system software with a LIVE, STANDBY or CLOSED status depending on whether or not they are available to potential first parties. A note with a STANDBY status is not yet available to the public, a note with a LIVE status is available to be included in emails and a note with a CLOSED status, is no longer available to the public as its corresponding advertisement campaign is closed.

Using the add 350 or edit 352 offer tool, an administration module user can add offer details to the list of notes stored for a particular client advertiser in the note database 142. Using the add note tool, an administration module user can add or edit the text for introduction, prize description, prize offer email address and hyperlink URL, brand message, advertiser's logo or hyperlink and associated note URL elements of a basic note template. The administration module user can also add a textual or graphical element to the advertiser's logo in the new note. The above details are validated and the resulting note is added to the list of stored notes with a STANDBY status designation. The administration module user and advertiser can view the note and may send themselves a test copy of the note. If the administration module user and advertiser are satisfied with the draft copy, the status of the note can be changed to LIVE.

Also using the add offer tool 350, the administration user can add details of the offer for display on the prize offer listing and prize offer web page including prize title, picture, value of prize, category, area prize is available in, klick check target, extended information on the prize, and extended information on promotor's note and a final closing date.

The add offer tool 350 includes input of questions for the survey data which may be included on the registration form (at option of the advertising client) to request issue of a note as a requirement for first party to complete before valid request is made. The data is stored in the campaign database for each advertiser.

The administration user may further view and edit an offer before confirming status of offer as live 354, standby 356, archived 358 or closed 360. Closing an offer removes it from the prize offers page. Deleting an offer 359 removes the offer and data from all databases.

(b) Front page offers and Top offers 370

The administration module user can select two offers to be featured on the home welcome page and can select up to seven top offers to be featured on the advertisers introduction page and website club pages.

V. Mailing Tool 312

Send Mail Tool 372

Using the send mail tool 372 a super administration module user can send an email to themselves, to an appropriate mailing list and club members. Using this tool, the super administration module user will be able to specify the body and the subject of the email. This tool can be used to send a live note to the recipients.

Email Offer 374

The administration module user can use the email offer tool 374 to send a note to themselves and to an appropriate mailing list. This tool adds the recipients email address into the text of the note.

Email Club 375

The administration module user can use the email club tool 375 to send a mail message to club members or a selected portion of members.

vi. News Tool 314

Using the add news stories tool 376 and the edit news stories tool 378, a super administration module user can create news stories, with a date and associated image. These stories are editable and deletable and are stored in the previous winners database 148. The news stories can be granted the status of LIVE or STANDBY 380, and accordingly, stories with a LIVE status appear on the winners archive section of the user's module 130.

vii. Download Database Tool 316

Using the download database tool 316 a super administration module user can download all relevant database content in CSV format to be sent to advertisers on termination of an advertising campaign. The downloaded information includes a list of the contact details and survey data from all the registrants for the relevant prize offer (obtained from the registration form for the prize-offer). The super administration module users can also use this tool to download data relating to web-site club membership in CSV format.

viii. Categories Tool 318

The super administration module user can add or delete categories. These are used to sort prize offers and to profile club members interests.

3. Logic Module

The logic module provides a suite of tools for:

(i) counting the recorded responses to issued notes (with independent auditing).

(ii) controlling the reporting system for issuing news-letters to web-site club members controlling the automatic clearing of prize offers from the list of available prize offers on termination of an advertising campaign and entry of new prize offers into the prize offer database 144.

(iii) Generating alerts when the target number of responses for a given advertising campaign has been recorded and triggering delivery of prize

4. Advertiser's Administration Module

All advertisers who participate in the marketing scheme and register with the scheme operators have access to their own suite of tools in the password protected advertiser's administration module (e.g. www.website.com/ADVERTISER/admin).

The tools made available to the advertiser in the advertiser's administration module include a report generation tool and a CSV upload tool.

(a) Report Generation Tool

Using the report generation tool reports can be generated by registered advertisers containing details of:

(ii) The current number of note responses recorded for a particular advertisement campaign.

(iii) The average number of note responses received within a 24 hour period

(iv) The percentage of note responses obtained through emails as opposed to the percentage of responses obtained through the hyperlink provided in the note.

(b) CSV Upload Tool

Using this tool an advertiser can populate their relevant section of the advertiser database 138, prize offers database 144 and campaign database 140 with files in CSV format through a provided form.

In a further embodiment each of the web-site sections can be made accessible through a personalised homepage by the provision of an additional page detailing offers of interest only to the visitor in question.

In a further embodiment, visitors to the web-site will be able to identify their home nation to select the language and home nation prizes.

In a further embodiment, users can be further enticed to register with the web-site club by offering the registrants further opportunities to win prizes with extra draws for prizes.

This invention is not limited to the embodiments herein described which can be varied in construction and detail.

What is claimed is:

1. A method of operating a marketing scheme comprising the steps of:
(a) registering a first party with the marketing scheme operator;
(b) issuing a respondable transmissible element to said first party for onward transmission to a plurality of receiving parties, said method of onward transmission being selected from the group consisting of direct transmission by said first party and indirect transmission by a receiving party who has received the transmissible element from one of said first and receiving parties;
(c) receiving a response to said transmissible element from a second party who is one of said plurality of receiving parties;
(d) accumulating the number of responses received from said plurality of receiving parties;
(e) comparing said accumulated number of responses with a target total; and
(f) delivering a first prize to said second party when said accumulated number of received responses equals the target total.

2. The method of operating the marketing scheme according to claim 1 wherein a second prize is also delivered to a third party from whom said second party received said transmissible element.

3. The method of operating the marketing scheme according to claim 1 wherein said second party is offered a transmissible element when said accumulated number of received responses is less than said target total.

4. The method of operating the marketing scheme according to claim 2 wherein said target total is established in accordance with the value and number of said first and second prizes.

5. The method of operating the marketing scheme according to claim 1 wherein a fourth party is registered with said marketing scheme operator prior to the commencement of said marketing scheme.

6. The method of operating the marketing scheme according to claim 5 wherein said fourth party donates at least one prize.

7. The method of operating the marketing scheme according to claim 5 wherein said fourth party determines said target total.

8. The method of operating the marketing scheme according to claim 5 wherein said first party is shown said prizes donated by said fourth party.

9. The method of operating the marketing scheme according to claim 8 wherein said first party is permitted to select a prize.

10. The method of operating the marketing scheme according to claim 8 wherein said first party is permitted to register to acquire said transmissible element.

11. The method of operating the marketing scheme according to claim 5 wherein a registration form is customised to meet the requirements of said fourth party.

12. The method of operating the marketing scheme according to claim 11 wherein said first party must complete said registration form before a transmissible element is issued thereto.

13. The method of operating the marketing scheme according to claim 12 wherein said transmissible element is sent to said first party in an email further including instructions on how said transmissible element should be transmitted to further parties.

14. The method of operating the marketing scheme according to claim 13 wherein said first party must transmit said transmissible element to a receiving party in order to win a prize.

15. The method of operating the marketing scheme according to claim 1 whereupon receipt of said transmissible element, said receiving party is advised of their chance to win said prize and is invited to respond to said transmissible element.

16. The method of operating the marketing scheme according to claim 15 whereupon responding to said transmissible element, said receiving party and said first party become said second party and third party respectively to the subsequent proceedings.

17. The method of operating the marketing scheme according to claim 5 wherein when said second party does not win said first prize, said second party is required to provide information in accordance with the requirements of said fourth party in order to obtain a transmissible element.

18. The method of operating the marketing scheme according to claim 17 whereupon receipt of said transmissible element said second party is advised on how to transmit said transmissible element to other parties.

19. The method of operating the marketing scheme according to claim 17 wherein said second party must transmit said transmissible element to a receiving party in order to win a second prize.

20. The method of operating the marketing scheme according to claim 19 wherein when said receiving party responds to said transmissible element, said second party and said receiving party become said third party and said second party respectively to the subsequent proceedings.

21. The method of operating the marketing scheme according to claim 20 wherein when said accumulated number of received responses matches said target total, said second party is requested to transmit information to a recording centre and to provide a copy of said transmissible element thereto to enable said recording centre to verify that said second party's email address is not identical of that of said third party.

22. The method of operating the marketing scheme according to claim 1 wherein when said first prize is won, registrants for said first prize are informed of the fact with a request that no further transmission are made in respect of said first prize and no further registrations therefor are accepted.

23. The method of operating the marketing scheme according to claim 10 wherein said registration of said first party is added to said accumulated number of received responses and when said first prize is delivered to said first party without the delivery of a second prize to said second party, the at least one remaining prize is used in a periodic random draw amongst all the registered parties.

24. The method of operating the marketing scheme according to claim 1 wherein said transmissible element is selected from the group consisting of HTML and textual messages.

25. The method of operating the marketing scheme according to claim 24 wherein said transmissible element further comprises instructions as to how it should be used to win a prize.

26. The method of operating the marketing scheme according to claim 24 wherein said transmissible element comprises responding means chosen from the group consisting of a hyperlink and an email address to a recording centre.

27. The method of operating the marketing scheme according to claim 24 wherein a fourth party is registered with said marketing scheme operator prior to the commencement of said marketing scheme and said transmissible element is customised in accordance with the requirements of said fourth party.

28. A system for implementing a marketing scheme comprising of a scheme database containing details of available marketing schemes and the at least one operators of said marketing schemes; a prize offer database containing details of prizes made available by the at least one marketing scheme operators; an advertisement database containing advertisements; and a response database containing details of respondents to said marketing scheme, wherein these databases are accessible by a user software module and a logic software module so that said prizes in said prize offer database are displayed by said user software module, details of registrants for said marketing scheme acquired by said user software module are stored in said response database and a generation of transmissible elements comprising of advertisements from said advertisement database, a transmission of transmissible elements to persons whose details are stored in said response database, a storage of responses to said transmissible elements in said response database and a decision process for prize grant are collectively controlled by said logic software unit.

29. A system for implementing a marketing scheme according to claim 28 wherein said system further comprises an administration module and an advertiser administration module, wherein said administration module enables suitably empowered parties to add marketing scheme operators, campaign details and marketing schemes to said scheme database and to generate reports of marketing scheme statistics and wherein said advertiser administration module enables suitably empowered marketing scheme operators to generate their own reports of statistics relating to their own marketing schemes and further add information relating to their marketing schemes to said scheme database.
